(19) United States
(12) Patent Application Publication
(10) Pub. No.: US 2005/0225963 A1
(43) Pub. Date: Oct. 13, 2005

(54) Cooling apparatus for light source

(75) Inventors: Kuo-Chin Huang, Chu-Nan (TW); Bor-Bin Chou, Chu-Nan (TW)

Correspondence Address: TROXELL LAW OFFICE PLLC;SUITE 1404, 5205 LEESBURG PIKE, FALLS CHURCH, VA, 22041, US

(73) Assignee: Coretronic Corporation

(21) Appl. No.: 10/986,085

(22) Filed: Nov. 12, 2004

(30) Foreign Application Priority Data
Apr. 7, 2004 (TW) 093109659

(51) Int. Cl. F21V 29/00

(52) U.S. Cl. 362/96; 362/294; 362/373

(57) ABSTRACT

This invention provides a cooling apparatus for a light source disposed in a housing, which comprises a light source, a fan device, and an air-flow guiding device. The light source is capable of providing an optical energy propagating outward in an optical path. The fan device is disposed in a predetermined distance for producing airflow. The air-flow guiding device is disposed between the light source and the fan device for guiding the airflow towards the light source to cool down the light source.

### BACKGROUND OF THE INVENTION

1. Field of the Invention

This present invention relates to a cooling apparatus, especially to a cooling apparatus for a light source.

2. Description of the Prior Art

In general, lamps are classified into two types, the closed-types and the open-types; no matter which type is being used, a light source capable of providing optical energy simultaneously generates heat, and therefore, the method to cool down lamps is very important. When the cooling effect is not so good, the lamp might blow up, or its lifespan is shortened, so the lamp fails to fulfill its function.

Referring to FIG. 1, FIG. 1 is a schematic diagram of a closed-type lamp 11 of the prior art. The lamp 11 comprises a fan device 10, a light bulb 12, a lampshade 14, and a translucent lid 16 mounted onto the front of the lampshade 14. As the lampshade 14 and the lid 16 enclose the heat produced by the lamp 11, part of the heat will accumulate on the lid 16, but an upward air flow generated by the fan device 10 from below the lamp 11 will cool down the lamp 11. However, the air flow produced by the fan device 10 is blocked by the lampshade 14 and the lid 16, so most of the air flow is bypassed without taking heat away along the surface of the lampshade 14 and the lid 16. As a result of this, the cooling effect is poor.

The prior art, regarding to cooling effect of closed-type lamps, utilizes an axial-flow fan, which usually can only be used with light bulbs of low-watts. If the light bulbs of high-watts are used, the rotational rate of the fan needs to be increased but the accompanying noise of the whole system also increases with the rapidly rotating fan.

Therefore, the objective of the invention is to provide a cooling apparatus for a light source to overcome the previously mentioned problems.

### SUMMARY OF THE INVENTION

Accordingly, one objective of the invention is to provide a cooling apparatus for a light source to guide the airflow towards the light source to cool down the light source.

Accordingly, another objective of the invention is to provide a cooling apparatus for a light source that effectively takes away the heat produced by the lamp by utilizing the location of an air-flow guiding device, which helps to direct cool air flowing along the front of the closed-type lamp.

The cooling apparatus for a light source of the present invention is disposed in a housing, which comprises a light source, a fan device, and an air-flow guiding device. The light source provides optical energy propagating outward in an optical path. The fan device is disposed at a predetermined distance from the light source for generating the air flow. The air-flow guiding device is disposed in the housing between the light source and the fan device for guiding the air flow towards the light source to cool down the light source.

In another better embodiment, the cooling apparatus for a light source of the present invention comprises a light source, a filter, a fan device and an air-flow guiding device. The light source is capable of providing optical energy propagating outward in an optical path. The filter is disposed in front of the light source to filter out infrared light and ultraviolet light included in the optical energy. The fan device is disposed in a predetermined distance from the light source to generate the air flow. The air-flow guiding device adheres to the fan device and guides the air flow towards the light source and the filter device to cool down the light source.

The cooling apparatus for a light source of the present invention comprises the air-flow guiding device, which guides the air flow generated by the fan device towards the light source to cool down the light source. Since the cooling effect of the light source of the present invention is good, it can be used in light bulbs with high-watts, and a lower rotational rate is enough to cool down the light source, thus also reducing the noise produced by the rotating fan. The cooling apparatus for a light source of the present invention is applicable in both open-type and closed-type lamps.

The advantage and spirit of the invention may be understood by the following recitations together with the appended drawings.

### BRIEF DESCRIPTION OF THE APPENDED DRAWINGS

FIG. 1 is a schematic diagram of a lamp with a fan device of the prior art.

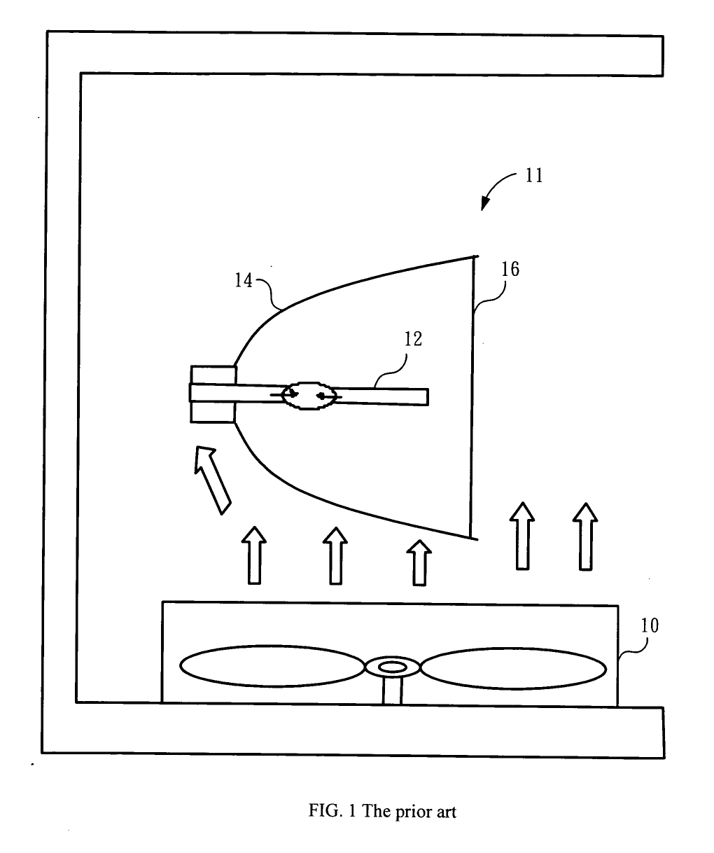

FIG. 2 is a schematic diagram of the cooling apparatus for a light source of the present invention.

FIG. 3 is the schematic diagram of the cooling apparatus for a light source of another embodiment of the present invention.

FIG. 4 is the schematic diagram of the cooling apparatus for a light source of another embodiment of the present invention.

### DETAILED DESCRIPTION OF THE INVENTION

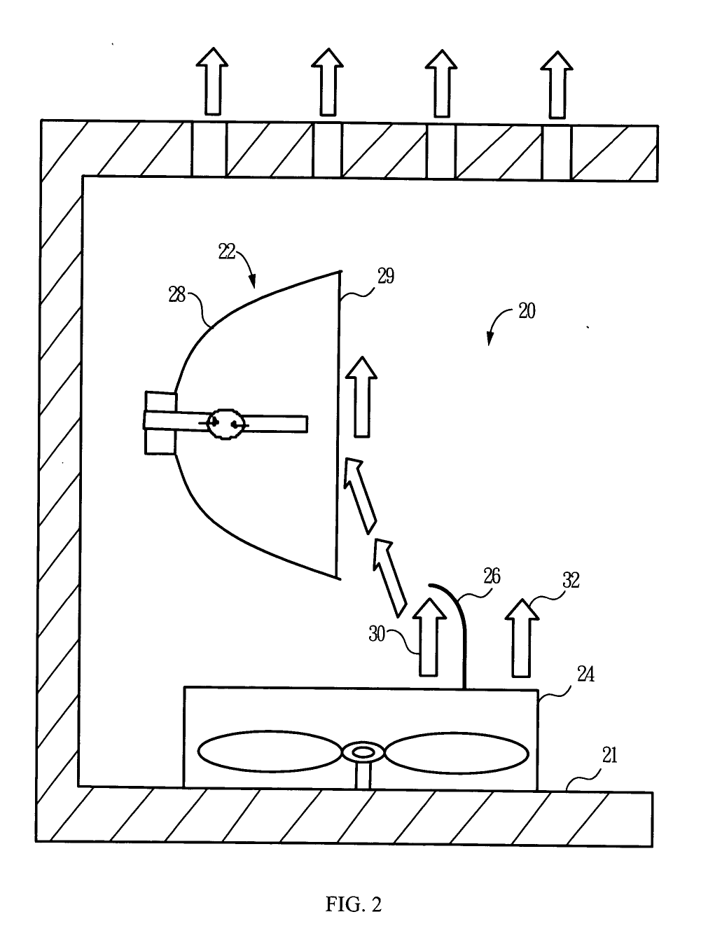

Referring to FIG. 2, FIG. 2 is the schematic diagram of the cooling apparatus 20 for a light source of the present invention. The cooling apparatus 20 for a light source is disposed in a housing 21, and it comprises a light source 22, a fan device 24, and an air-flow guiding device 26.

The light source 22 is capable of providing an optical energy propagating outward in an optical path. The light source 22 comprises a lampshade 28; in front of the lampshade 28 is a translucent lid 29, which forms a closed-type lamp, and the optical energy projects in the optical path outwards through the lid 29 of the lampshade 28.

The fan device 24 is disposed below the light source 22 to generate the air flow. The air-flow guiding device is disposed between the light source and the fan device; the air-flow guiding device is an arc-shaped device formed from a heat-resistant material for guiding the air flow along the front of the light source 22 to cool down the light source. The air-flow guiding device does not block the lid 29 of the lampshade 28 because if the air-flow guiding device 26 is larger than the lid 29 of the lampshade 28, it will block the optical path of the propagation of the optical energy. As the light source is the part with the highest temperature in the whole optical system or lamp, an air-flow guiding device that guides the air flow towards the light source will substantially cool down the whole optical system or lamp.

The air-flow guiding device 26 divides the air flow generated by the fan device 24 into a first branch flow 30 and a second branch flow 32, and it guides the first branch flow 30 towards the lid 29 in front of the lampshade 28.

In an application of the cooling apparatus 20 for a light source of the present invention, as the air-flow guiding device 26 guides the air flow generated by the fan device 24 towards the lid 29 in front of the lampshade 28 by controlling the direction and the angle of the air flow, it increases the surface of contact between the air flow and the lamp 28, thus effectively taking away the heat for enhancing the cooling effect. Since the cooling effect of the present invention is better in comparison with the prior art, the cooling apparatus 20 for a light source of the present invention can be applied in lamps with high-watt bulbs; moreover, the fan device correspondingly does not need the higher rotational rates for the high-watt bulbs as in the prior art, further achieving the objective of putting the noise produced under control.

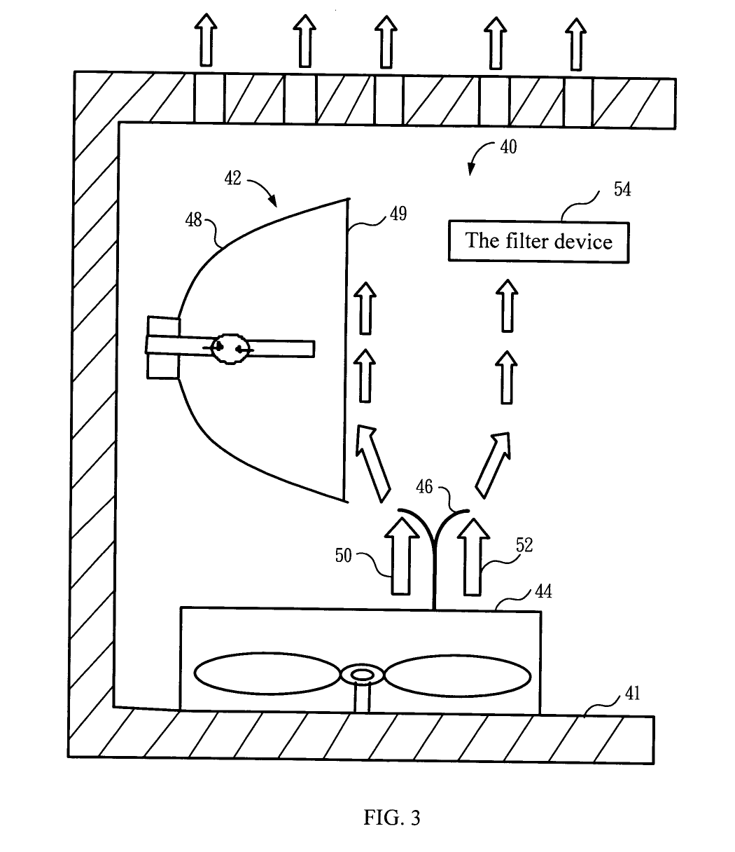

Referring to FIG. 3, FIG. 3 is the schematic diagram of the cooling apparatus 40 for a light source of another embodiment of the present invention. The cooling apparatus for a light source of this embodiment is disposed in a housing 41 of a projector apparatus, which comprises a light source 42, a filter 54, a fan device 44, and an air-flow guiding device 46.

The light source 42 is capable of providing an optical energy propagating outward in an optical path. The light source 42 comprises a lampshade 48, which comprises a lid 49, wherein the optical energy projects outwards through the lid 49 of the lampshade 48. The filter 54 is disposed in front of the light source 42 to filter out infrared light and ultraviolet light included in the optical energy. The fan device 44 is disposed below the light source to generate the air flow.

The air-flow guiding device 46 is disposed between the fan device 44 and the light source 42, and it is composed in a Y-shape from heat-resistant material. The air-flow guiding device does not block the optical path of the propagation of the optical energy. The air-flow guiding device 46 is capable of guiding the air flow towards the light source 42 and the filter 54 to cool down the light source. The air-flow guiding device 46 divides the air flow generated by the fan device 44 into a first branch flow 50 and a second branch flow 52. The air-flow guiding device 46 guides the first branch flow 50 towards the lid 49 of the lampshade 48 and guides the second branch flow 52 towards the filter 54, so as to cool down the light source of the projector apparatus by the air flow flowing outwards from the housing of the projector apparatus (as shown by the arrows).

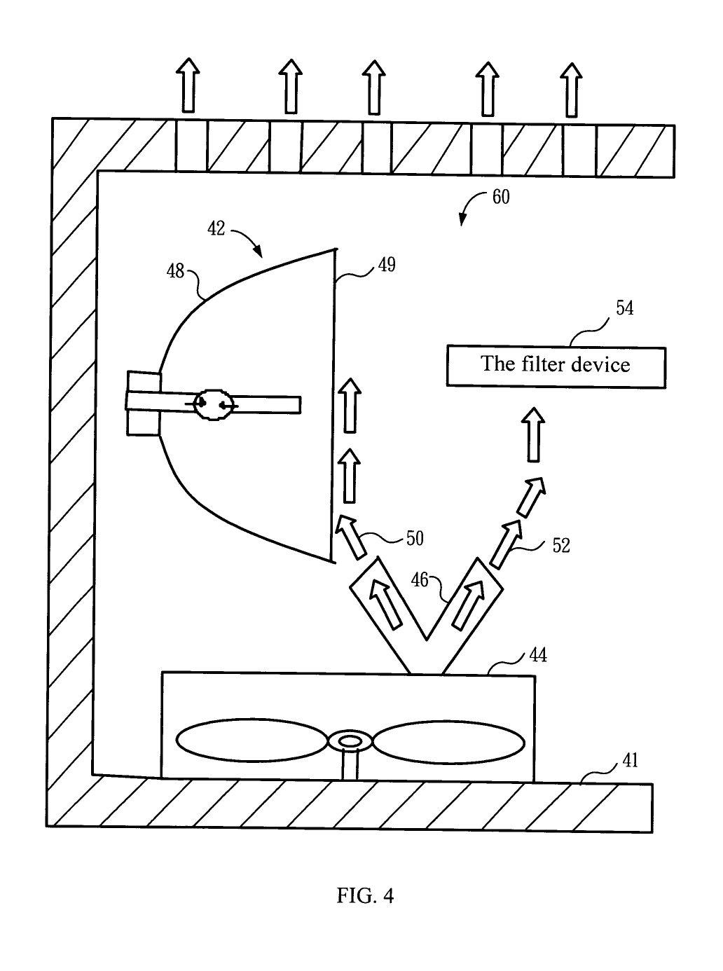

Referring to FIG. 4, FIG. 4 is a schematic diagram of the cooling apparatus 60 for a light source of another embodiment of the present invention. As illustrated in FIG. 4, the air-flow guiding device 46 of this embodiment is formed from a tubular and heat-resistant material, and when the air flow produced by the fan device 44 flows through the tubular air-flow guiding device, the airflow is divided into a first branch flow 50 and a second branch flow 52; the temperature of the light source 42 is cooled down by the first-branch flow 50, and the temperature of the filter is cooled down by the second branch flow 52.

In the cooling apparatus for a light source of the present invention, the air-flow guiding device is not limited to the three types mentioned above. As long as the objective of guiding the air flow towards the predetermined direction can be achieved, any heat-resistant material can be used for the air-flow guiding device of the cooling apparatus for a light source of the present invention.

When the light source is a closed-type lamp, part of the heat will accumulate on the front of the light source 42, and the air-flow guiding device makes the air flow produced by the fan device 44 flow along the lid 49 in front of the light source 42, so as to effectively take away the heat accumulated on the lid, thus enhancing the cooling effect of the light source 42.

The cooling apparatus for a light source of the present invention comprises the air-flow guiding device, which cools down the light source by guiding the air flow generated by the fan device towards the light source. When optical device is designed in a way that the light source is operated in coordination with the filter, the air-flow guiding device of the invention guides the air flow towards the light source and the filter corresponding to the design to cool down the light source. Since the cooling effect of the cooling apparatus for a light source is good, it is applicable for lamps with high-watt bulbs, and besides, cooling down the light source with relatively lower rotational rates also reduces the noise produced by fan rotating. The cooling apparatus for a light source of the present invention can be applied in both closed-type and open-type lamps.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A cooling apparatus for a light source disposed in a housing, comprising:
a light source providing an optical energy propagating outward in an optical path;
a fan device, being at a predetermined distance from the light source, for generating an air flow; and
an air-flow guiding device, disposed in the housing between the light source and the fan device, for guiding the air flow toward the light source to cool down the light source.

2. The apparatus of claim 1, wherein the predetermined distance is for the fan device to effectively cool down the light source.

3. The apparatus of clam 1, wherein the predetermined distance is long enough to contain the air-flow guiding device.

4. The apparatus of claim 1, wherein the air-flow guiding device does not block the optical path of the propagation of optical energy.

5. The apparatus of claim 1, wherein the air-flow guiding device also divides the air flow generated by the fan device into a first branch flow and a second branch flow.

6. The apparatus of claim 1, wherein the air-flow guiding device is a Y-shaped device formed from heat-resistant material.

7. The apparatus of claim 1, wherein the air-flow guiding device is a Y-shaped and tubular device formed from heat-resistant material.

8. The apparatus of claim 1, wherein the air-flow guiding device is an arc-shaped device formed from heat-resistant material.

9. The apparatus of claim 1, wherein the light source is a closed-type lamp.

10. The apparatus of claim 9, wherein the light source also comprises a lampshade and a lid mounted onto the front of the lampshade.

11. The apparatus of claim 10, wherein the air flow can be guided by the air-flow guiding device to flow along the surface of the lid.

12. The apparatus of claim 1, wherein a filter device is disposed in front of the light source.

13. The apparatus of claim 12, wherein the air-flow guiding device also divides the air flow into a first branch flow and a second branch flow, and guides the first branch flow towards the light source, and guides the second branch flow towards the filter device.

14. The apparatus of claim 1, wherein the housing is a housing of a projector apparatus.
